(19) United States
(12) Patent Application Publication
(10) Pub. No.: US 2021/0125292 A1
(43) Pub. Date: Apr. 29, 2021

(54) Transportation Hub Concierge Mobile Device Software Application

(71) Applicant: Michelle Beckett, Philadelphia, PA (US)

(72) Inventor: Michelle Beckett, Philadelphia, PA (US)

(21) Appl. No.: 16/664,768

(22) Filed: Oct. 25, 2019

(51) Int. Cl. G06Q 50/14; G06Q 50/26; G06Q 10/10; H04L 29/08

(52) U.S. Cl. CPC G06Q 50/14; G06Q 50/265; H04W 88/02; H04L 67/10; G06Q 10/1097

(57) ABSTRACT

A transportation hub concierge mobile device software application is disclosed. The invention comprised of a subscription application (app) installed on a mobile electronic device that allows transparency within concierge services at large transportation hubs such as airports and train terminals. Users connect with participating concierge personnel or airport service employees performing concierge services on their mobile electronic devices and deliver those with special needs (such as elderly or disabled) into their care. The app then allows a user to then monitor the individual's progress through a terminal in real time and receive a confirmation image from the concierge that the person has boarded safely.

### CROSS-REFERENCE TO RELATED APPLICATIONS

This application claims the benefit of U.S. Provisional Patent Application of the same title filed on Oct. 28, 2018 with confirmation number 102918INTEFSW17474300.

### FIELD OF THE INVENTION

The present invention generally relates to mobile device application software. More specifically, it relates to a mobile application that enhances concierge services.

### BACKGROUND

The word Concierge comes from the French and means ‘keeper of the keys.’ During the Middle Ages, concierges kept the keys to castle rooms for visitors and ensured that guests had everything they needed during their stay. By the 1800s, a number of buildings in Europe, from government offices to prisons, had their own concierge on staff. In the 20th century, the introduction of steamships and steam trains and eventually the airplane the modern travel industry was born. Guests from distant locales relied on hotel employees for tour assistance and other services during their stays. Hotels throughout Europe began creating concierge positions to take care of their guests. Today, concierge services have generally dwindled as more travelers turn to the internet when making travel preparations. However, concierges still play a vital role in large transportation hubs at airports and large train terminals. Due to increased security, these stations tend to be somewhat isolating for those who require special assistance and are traveling alone. The concierge industry has recognized this vulnerability and has begun adopting communication technology to enhance the experience. U.S. Pat. No. 8,215,546B2 is an software system that allows user to check in at a terminal and search for fares that include accommodations for elderly; however, it does not connect them directly with concierges. U.S. Pat. No. 9,367,217B2 uses technology as a substitute for a concierge in the form of a ‘virtual helper.’ U.S. Pat. No. 8,138,907B2 teaches of a mobile device app that allows a person with a disability to travel independently and be tracked by a loved one but is not used in conjunction with a concierge per se.

### SUMMARY OF THE INVENTION

The device herein disclosed and described provides a solution to the shortcomings in the prior art through the disclosure of a transportation hub concierge mobile device software app. An object of the invention is to make travel safer for those who require special needs. Many times, family members drop off individuals at large transportation hubs who are traveling alone but need assistance from a concierge to purchase tickets, go through security checkpoints, find a gate, and board a transport vehicle such as a passenger jet, cruise ship or train. In some instances, concierge services can fail such an individual and leave them stranded or worse vulnerable to strangers. The invention disclosed herein enhances the safety of such travelers. For example, when a daughter drops off her elderly mother (who has trouble using a cell phone) at a busy airport terminal, they use the app to find a participating concierge. The concierge is notified and meets the traveler quickly. The mother is then escorted through a terminal at all times by the concierge and the app requires them to check in with the woman's daughter at points along the way as they navigate ticket counters, security points and boarding areas. Another object of the invention is to provide reassurance to those who have dropped off a traveler with special requirements. In the example above, the app allows the daughter to track her mother's progress through the terminal remotely by way of the concierge's mobile device location. When the woman is boarding the plane, the concierge snaps a photo of her and it is sent directly to the daughter's mobile device providing assurance in real time that her mother is safely on her way.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention with stakeholders.

FIG. 2 shows a perspective view of the invention confirming traveler safe.

FIG. 3 shows a diagrammatic view of invention functions.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

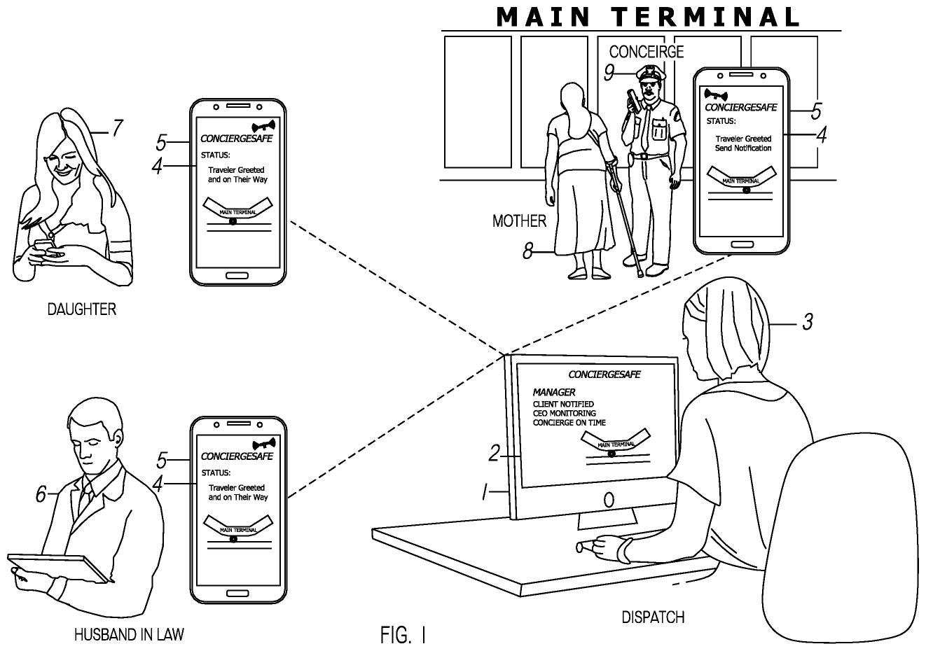

FIG. 1 shows a perspective view of the invention with stakeholders. The invention comprised of a software application 4 being written from code that may include, but not be limited to: Java, C++, Visual Basic, Fortran, Basic and the like. The software also compatible with a plurality of operating systems such as, but not limited to: Windows Apple and Android and compatible with a multitude of hardware platforms such as, but not limited to: personal desktops 1, laptops, tablets, smartphones 5 and the like. The figure showing daughter notifying concierge service provider 3 that her mother 8 has arrived via services such as, but not limited to: text, SMS, audio, video, images and phone conversations etc. A concierge 9 also being notified on mobile electronic device 6 and meeting the mother 8 at a terminal to begin the accommodations process. Said application 4 sending a signal to all stakeholders and showing, but not limited to, the location of the traveller on the terminal property. Other embodiments may include the inclusion of transportation hub employees performing concierge services.

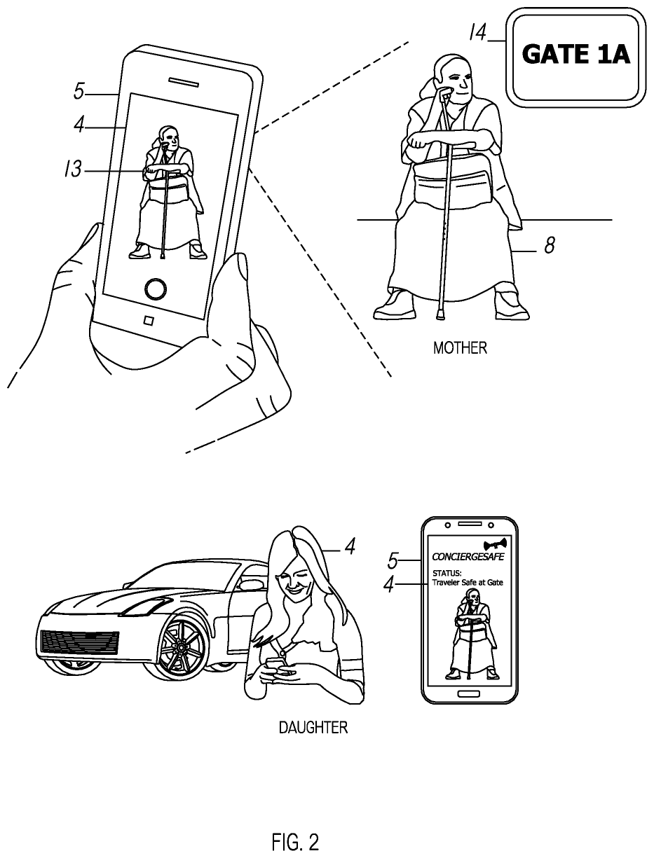

FIG. 2 shows a perspective view of the preferred embodiment of the invention confirming traveler safe at the gate 14. The concierge service providers gathering evidence of the safe traveler 8, such as but not limited to: text, SMS, phone conversation, digital images, video and audio 13 and then sending images directly to daughter 4 and stakeholders allowing them to acknowledge safe passage of the traveler through various checkpoints (security, gates, etc.).

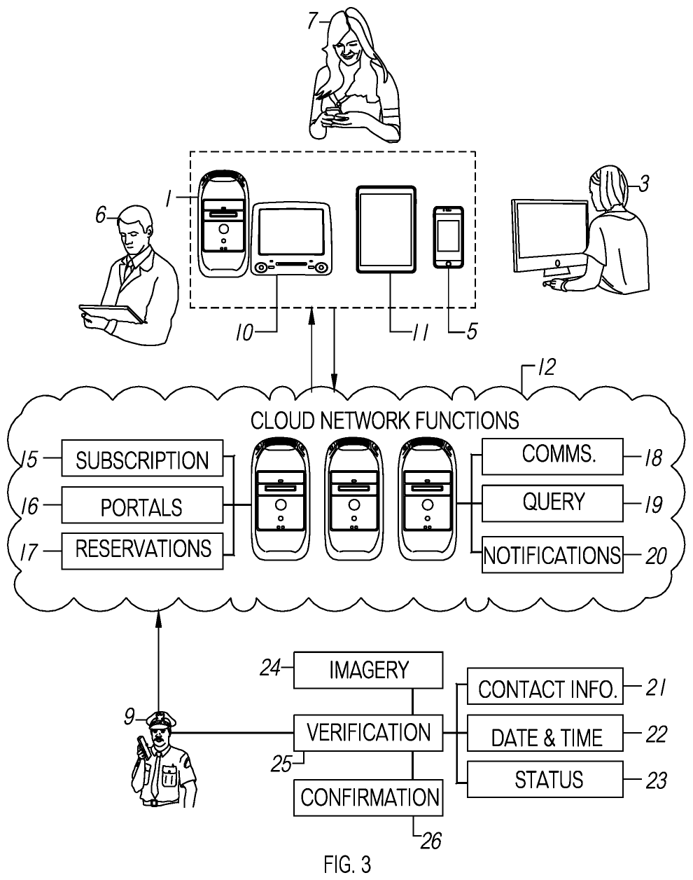

FIG. 3 shows a diagrammatic view of invention functions. Concierge 9 having the ability to input functions such as, but not limited to: verification notifications 25, confirmation messages 26. The account of the concierge having secured access to, but not limited to: traveler profile with guardian and traveler contact information (telephone number, address, name etc.); expected date and time of arrival at a terminal; and the ability to notify dispatch and guardian of checkpoint completions 23. All signals between stakeholders being routed over wireless signals to cloud network 12. The cloud network 12 hosting a multitude of servers containing a plurality of algorithms including, but not limited to: subscription management 15 (online payment transactions and banking connections), stakeholder portals 16 (security access hierarchies), reservation management (between dispatch and customers); stakeholder networking and communication 18 (notification and alerts); query management 19 (customer driven updates); and alerts and notifications 20 (emergency notifications). The figure finally showing end terminal devices such as, but not limited to personal computers 1 (mac, PC and the like); cable ready televisions 10; tablets 11; and smartphones 5. Other embodiments of the invention allowing a user to schedule concierge services with concierge service providers who utilize the software application.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A mobile transportation hub concierge service comprising:
(a) a software application;
(b) a cloud network; and
(c) a mobile electronic device.

2. The mobile transportation hub concierge service of claim 1 wherein the software application operating on the mobile electronic device.

3. The mobile transportation hub concierge service of claim 1 wherein the cloud network configured to store profiles of users, said profiles including traveler information, guardians contact information, hub arrival time and travel itinerary.

4. The mobile transportation hub concierge service of claim 1 wherein the cloud network having algorithms to perform automatic notification operations among travellers, concierge service providers and guardians.

5. The mobile transportation hub concierge service of claim 1 wherein the software application including instructions for a user login, entered into a mobile electronic device running the application program, to be transmitted from the mobile electronic device to the cloud network.

6. The mobile transportation hub concierge service of claim 1 wherein the cloud network, in response to receiving the user login, being programmed with instructions to compare the received user login to stored user logins associated with the stored user profiles, and if the received user login matches one of the stored user logins, to transmit user profile information from the corresponding stored customer profile to the mobile electronic device and to concierge and guardians' mobile devices.

7. The mobile transportation hub concierge service of claim 1 wherein the mobile device including a GPS component configured to transmit its location, as determined by the GPS component, to the cloud network.

8. The mobile transportation hub concierge service of claim 1 wherein the mobile device including a camera component configured to transmit images, taken by the camera component and transmitting said images to the cloud network and accessible by guardians' mobile devices.

9. A method for enhancing concierge service, the method including the following steps:
(a) establishing a traveler profile;
(b) scheduling concierge services between concierge service providers, travelers and their guardians;
(c) informing concierge service providers of traveler's arrival at the transportation hub automatically;
(d) notifying guardians of traveller's location on the hub transportation hub property automatically;
(e) obtaining digital evidence of traveller's safety within transportation hub check points; and
(f) sending digital evidence of traveller's safety within transportation hub check points to guardians.

10. The method for enhancing concierge service of claim 9 wherein the informing concierge service providers of traveler's arrival at the transportation hub automatically being performed by the algorithm on the cloud network of claim 1.

11. The method for enhancing concierge service of claim 9 wherein the notifying guardians of traveller's location on the hub transportation hub property automatically being performed using the GPS of claim 7.

12. The method for enhancing concierge service of claim 9 wherein the obtaining and sending digital evidence of traveller's safety within transportation hub check points; being performed on the concierge service providers' mobile devices.
